(19) United States
(12) Patent Application Publication
(10) Pub. No.: US 2013/0173496 A1
(43) Pub. Date: Jul. 4, 2013

(54) MULTICAP VALUE INVESTMENT METHODOLOGY

(71) Applicants: Bruce A. Matheson, Fair Lawn, NY (US); Eric M. Knight, Ridgewood, NJ (US)

(72) Inventors: Bruce A. Matheson, Fair Lawn, NY (US); Eric M. Knight, Ridgewood, NJ (US)

(21) Appl. No.: 13/729,659

(22) Filed: Dec. 28, 2012

Related U.S. Application Data
(60) Provisional application No. 61/581,414, filed on Dec. 29, 2011.

(51) Int. Cl. G06Q 40/06

(52) U.S. Cl. CPC G06Q 40/06
USPC 705/36 R

(57) ABSTRACT

A system and method manages an investment portfolio. The system includes at least one processor programmed to receive performance data for a plurality of investable entities forming a market. Risk adjusted discount cash flow (RA-DCF) values are then calculated for the investable entities using the received performance data. In response to at least one trigger, a predetermined number of the investable entities with RA-DCF values less than corresponding current market values are selected and the investment portfolio is rebalanced to include the selected investable entities.

### BACKGROUND

The present exemplary embodiment relates generally to the field of financial services. It finds particular application in conjunction with the selection and investment in equity securities, and will be described with particular reference thereto. However, it is to be appreciated that the present exemplary embodiment is also amenable to other like applications.

The last 20 years have seen multiple bear markets (market declines of 20%) and multiple market corrections (market declines of 10%). The preponderance of mutual funds typically ignore these events and employ a long equity buy and hold investment strategy. In other words, mutual funds buy and hold until the market goes up. Hence, such a strategy manages market cycle risk by employment of long term investment horizons and looks to dollar cost average. However, this strategy assumes the market on average will go up over time. While this assumption used to hold, it no longer holds. As such, this strategy is no longer a match for market volatility and results in inflation adjusted negative returns.

The alpha cost of buy and hold strategies is typically 7-9%. That is mutual funds will give up 7% to 9% in potential returns by dollar averaging versus either active hedging or market exit. The associated standard deviation cost is typically 8-10%. Alpha is a measure of selection risk (also known as residual risk) of a mutual fund in relation to the market. A positive alpha is the extra return awarded to the investor for taking a risk, instead of accepting the market return. Standard deviation is a statistical measure of the range of a fund's performance and is reported as an annual number. When a fund has a high standard deviation, its range of performance has been very wide, indicating that there is a greater potential for volatility.

Hedge funds, in contrast with mutual funds, manage cycle risk with many different strategies including directional strategy shifts and shorting. Directional strategy shifts often include asset class substitution. Shorting is the practice of selling assets, usually securities, that have been borrowed from a third party, usually a broker, with the intention of buying identical assets back at a later date to return to that third party. Combining these strategies with leverage, has the potential effect of working very well or resulting in a large error. This, in turn, causes a large amount of volatility and risk, which is less than ideal when investing.

Regardless of how market cycle risk is managed, most investment strategies identify and invest in equities with a strong singular disposition toward growth analysis and prediction. However, predicting growth is highly uncertain and hence the probability of equity accretion is less certain. Therefore, identifying equities with a focus on growth analysis has over the past 12 years as measured by Morningstar or Lipper mutual fund performance lead the majority of mutual funds of large, mid-cap and multi-cap to returns of 2%-7% and reported standard deviations of 20% to 30%

Further, most active manager investment strategies diversify with a limited number of companies, typically less than 50. Index funds are typically widely diversified. Both active limited selection and non-discriminatory selection through indexing increase risk and susceptibility to market cycle downturns. Active limited diversification has historically been due to the time required to manually identify and pick values. The identification of values typically requires reviewing large volumes of performance information reported by a large number of companies and calculating discounted cash flow (DCF) values. It wasn't until fairly recently (i.e., roughly within the last 10 years) that the information required to identify values with computers has become available in electronic form.

In October 2009, The United States Securities and Exchange Commission (SEC) adopted rules requiring companies to provide financial statement information in a form that is intended to improve its usefulness to investors. In this format, financial statement information could be downloaded directly into spreadsheets, analyzed in a variety of ways using commercial off-the-shelf software, and used within investment models in other software formats. The rules apply to public companies and foreign private issuers that prepare their financial statements in accordance with U.S. generally accepted accounting principles (U.S. GAAP), and foreign private issuers that prepare their financial statements using International Financial Reporting Standards (IFRS) as issued by the International Accounting Standards Board (IASB). Companies provide their financial statements to the SEC and on their corporate web sites in interactive data format using the eXtensible Business Reporting Language (XBRL). The interactive data is required to be provided as an exhibit to periodic and current reports and registration statements, as well as to transition reports for a change in fiscal year. The rule was intended not only to make financial information easier for investors to analyze, but to assist in automating regulatory filings and business information processing.

Advantageously, the information collected by the EDGAR system is available to the public, thereby allowing automated value identification. One challenge with value identification directly with the EDGAR system, however, is that companies typically employ different ways of reporting and calculating accounting parameters, such as, for example, revenue, depreciation and so on. Hence, third parties have taken the information available in the EDGAR system and standardized the various accounting expressions to common information groupings corresponding to Generally Accepted Accounting Principles (GAAP). Such third parties typically make the information available in eXtensible Business Reporting Language (XBRL) form. XBRL uses Extensible Markup Language (XML) for information modeling and the expression of semantic meaning commonly required in business reporting.

The present disclosure provides a new and improved system which overcomes the above-referenced problems and others.

### BRIEF DESCRIPTION

According to one aspect of the present disclosure, a system and method for selecting and managing an investment portfolio is provided. The system includes at least one processor programmed to receive performance data for a plurality of investable entities forming a market. Risk adjusted discount cash flow (RA-DCF) values are then calculated for the investable entities using the received performance data. In response to at least one trigger, a predetermined number of the investable entities with RA-DCF values less than corresponding current market values are selected and the investment portfolio is rebalanced to include the selected investable entities.

According to one aspect of the present disclosure, a method for selecting and managing an investment portfolio is provided. The method includes receiving performance data for a plurality of investable entities forming a market. RA-DCF values for the investable entities are calculating by at least one processor using the received performance data. In response to at least one trigger, a predetermined number of the investable entities with RA-DCF values less than corresponding current market values are selecting by the processor and the investment portfolio is rebalanced to include the selected investable entities.

### BRIEF DESCRIPTION OF THE DRAWINGS

FIG. 1 is a block diagram of a system implementing a multicap value investment methodology;

FIG. 2 is a block diagram of the present concepts described in a modular arrangement;

FIG. 3 is a block diagram of a multicap value investment methodology; and,

FIG. 4 is a table comparing the performance of an investment methodology with the Standard & Poor's 500.

### DETAILED DESCRIPTION

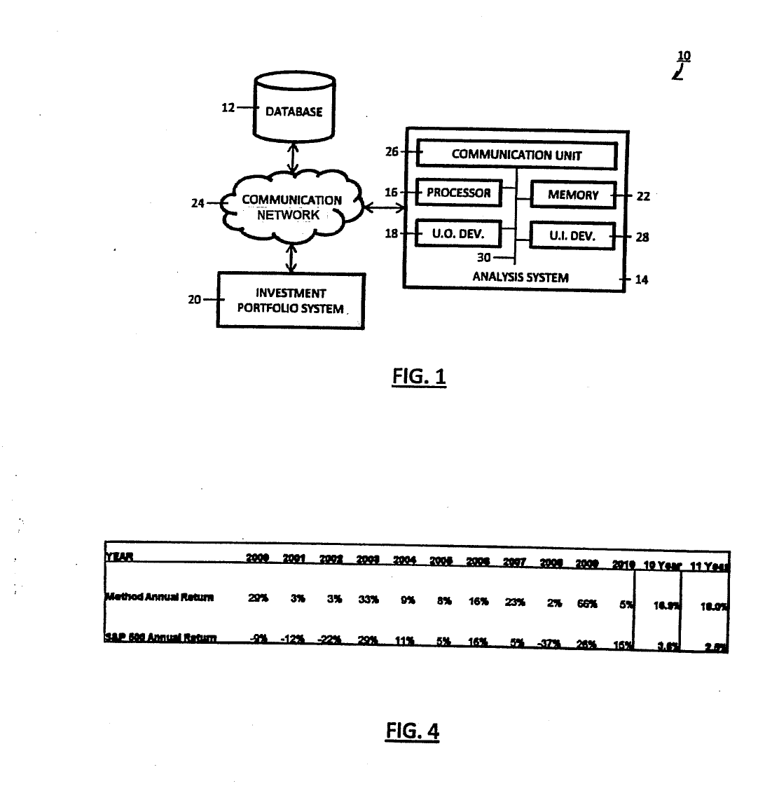

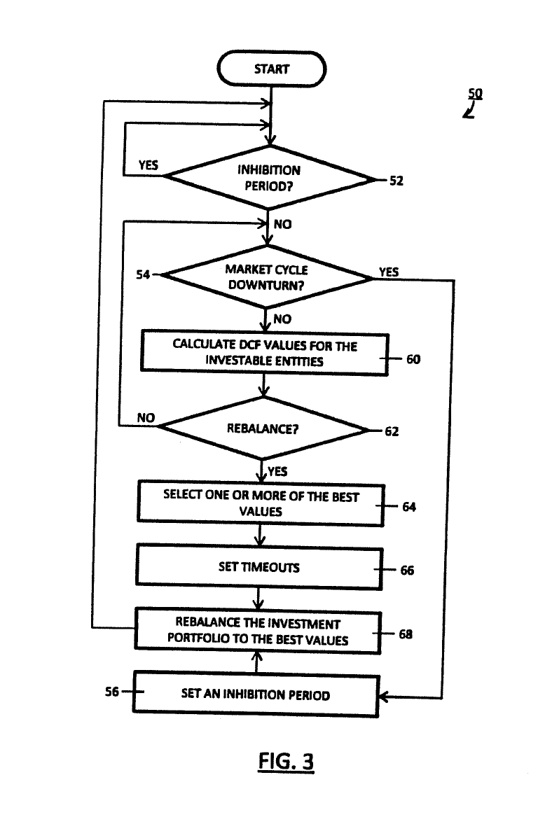

With reference to FIG. 1, an investment system 10 implementing a multicap value investment methodology 50 (see FIG. 3) is provided. The system 10 determines how and when to invest in a market of equity securities for a plurality of investible entities. Typically, the market is the U.S. equity securities market, but other markets, such as equity securities markets of other countries are contemplated. An equity security is an instrument that signifies an ownership position in an investible entity. The investible entities are typically publically traded corporations, but the present concepts are applicable to other investible entities.

The investment system 10 includes at least one database 12 of performance data for the investible entities. For each of the investable entities, the performance data describes the performance of the investable entity over a predetermined amount of time, such as, but not limited to, the past 1 to 20 years and/or some increment thereof. The temporal resolution of the performance data for an investable entity is typically quarterly or yearly, but other temporal resolutions are contemplated. Performance data includes, for example, sales, revenue, profits, growth rate, market capitalization, and so on.

In some embodiments, the performance data includes 10-K statements of the investable entities. For example, in some embodiments the database 12 includes data based on information from the Electronic Data Gathering, Analysis, and Retrieval (EDGAR) system, which includes 10-K statements for companies defining 12 market sectors, including basic materials, capital goods, consumer non-cyclical, consumer cyclical, services, energy, health, technology, transportation and conglomerates. As noted above, a 10-K statement is an annual report required by the U.S. Securities and Exchange Commission (SEC) that gives comprehensive information of a public company's performance.

The database 12 further includes the current value of equity securities and, optionally, debt securities for the investable entities. The database 12 can include any other data indicating the performance of the investable entities, such as market capitalization, market beta, and so on, as well as data relevant to the volatility of the company. Additionally, the database 12 can include performance data for the market, such as market indexes. Examples of market indexes includes the Dow Jones Industrial Average (DJIA), the Standard & Poor's 500 (S&P 500), and so on.

An analysis system 14 of the investment system 10 includes at least one processor 16 that analyzes the performance data according to the multicap value investment methodology 50, hereafter discussed in detail, to maintain an investment portfolio. The investment portfolio includes holdings in equity securities of at least one of the investable entities, cash, debt securities and/or other tangible assets. The investment portfolio is typically part of an investment account with a financial institution, such as a brokerage firm, which adjusts the composition of the investment account in response to financial instructions to do so from an authorized party, such as the operator of the analysis system 14 or the account holder. Typically, the operator of the analysis system 14 and the financial institution are different parties, but they can be the same party.

Maintaining the investment portfolio includes adjusting the composition of the investment portfolio. Typically this includes selecting investable entities to invest in and rebalancing the investment portfolio according to the selection. The composition of the investment portfolio is adjusted in response to events and/or conditions. For example, in response to a market downturn, the investment portfolio may be shifted to all cash. As another example, in response to the passing of a period of time, the investable entities of the investment portfolio may be changed.

Adjusting the composition of the investment portfolio can require action of an operator of the analysis system 14 or be automatic without action of the operator. As to the former, the analysis system 14 outputs the determined composition of the investment portfolio to a user output device 18, such as a display. It then falls to the operator to implement the changes to the investment portfolio, optionally after reviewing the information. As to the latter, the analysis system 14 sends the determined composition to an investment portfolio system 20 which adjusts the composition of the investment portfolio in response to instructions to do so. The investment portfolio system 20 can be local to the analysis system 14 (i.e., the two systems 14, 20 are one and the same) or remote from the investment portfolio system 20. Further, the investment portfolio system 20 is typically maintained and operated by the financial institution.

The processor 16 performs the methodology 50 by executing computer executable instructions embodying the methodology 50. The computer executable instructions are suitably stored on at least one memory 22 of the analysis system 14. Further, the processor 16 communicates with components of the investment system 10 remote from the analysis system 14 over at least one communication network 24, such as the Internet, with a communications unit 26. In some embodiments, the analysis system 14 includes a user input device 28 allowing an operator of the analysis system 14 to provide input to the methodology 50 and/or adjust parameters thereof. Suitably, the processor 16, the memory 22, the user output device user input device 18, the user input device 28, and the communication unit 26 communicate using at least one databus 30.

The database 12 can be local or remote to the analysis system 14, but is typically remote from the analysis system 14. Where the database 12 is local, the processor 16 communicates with the database 12 over the databus 30. Where the database 12 is remote, as illustrated, the processor 16 communicates with the database 12 over the communication network 24 using the communication unit 26. Performance information retrieved from the database 12 is suitably formatted using eXtensible Business Reporting Language (XBRL).

The same party or separate parties can maintain and operate the database 12 and the analysis system 14. However, the database 12 and the analysis system 14 are typically maintained and operated by separate parties. For example, where the database 12 includes the EDGAR database, the database 12 can be maintained and operated by the SEC and the analysis system 14 can be maintained and operated by another party, such as an investor. Further, in some embodiments, where the database 12 includes a plurality of databases, a plurality of parties can maintain and operate the databases.

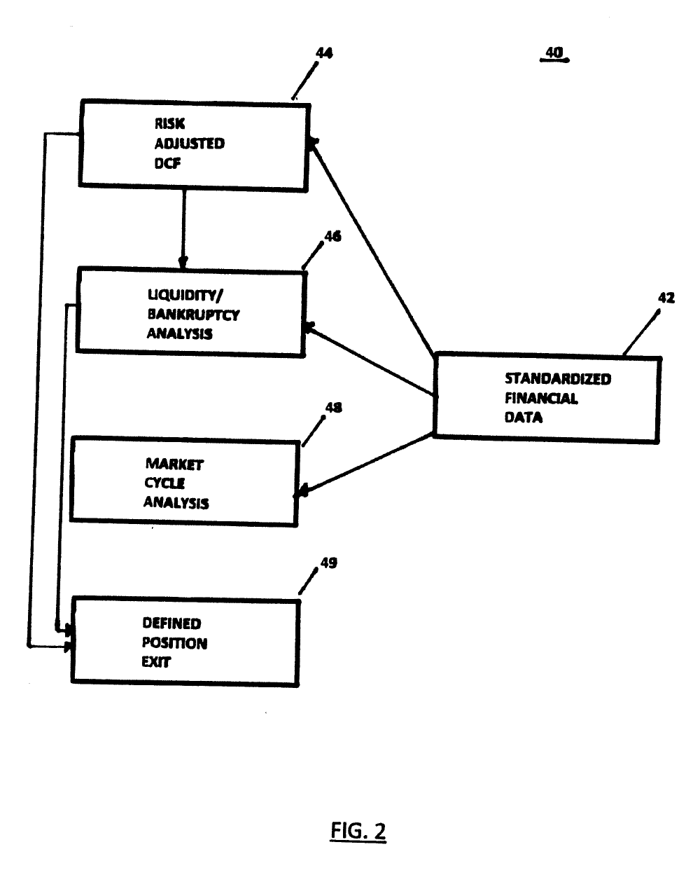

Turning to FIG. 2 depicted is a block diagram 40 defining aspects of the present application in the format of system modules corresponding to operations described herein.

Standardized Financial Data module 42 contains financial data related to potential investable entities, financial data related to security markets in which shares of stocks of the investable entities are bought and sold, financial data related to debt of the investable data, as well as other financial or economic data. In one embodiment, at least a portion of the financial data is presented in a standardized XBRL format. It is appreciated however, that other financial data reporting standardization formats may also be useful in the present application. For example, the United States and/or other countries may adopt standardized reporting requirements that employ a formatting different from XBRL and/or EDGAR. It is to be understood the data of the Standardized Financial Data module 42 may be a sub-set of data contained in the at least on database 12 of FIG. 1.

With continuing attention to FIG. 2 also depicted are Risk Adjusted Discount Cash Flow (DCF) module 44, Liquidity/Bankruptcy Analysis module 46, Market Cycle Analysis Module 48, and Defined Position Exit module 49. These modules and their interaction with Standardized Financial Data module 42 and each other will be described below.

Initially, however, it is mentioned that in the present system and methodology it is to be understood that time is an elemental dimension of the decision-making process. Namely, time alone may trigger an action irrespective of other situations, for example time may trigger an action irrespective of any gains or losses of any particular equity security position. In other situations, time is used in combination with other dimensions such as the state of the overall market, where the combination of these dimensions trigger an action.

Also, another aspect of the present disclosure is that actively managed portfolios created by the present system and methodology, employ a much larger diversification of equity positions (e.g., stocks) than existing investment theories would consider acceptable. Particularly, some theories related to actively managed portfolios identify a proper diversification as being 11 to 28 different equity positions, others argue for a somewhat larger number of 28 to 40 equity positions. However, the present system and methodology, in one embodiment, employs a diversification strategy of holding 100 to 300 positions, (and preferably approximately 200 different positions) at one time.

An aspect of this diversification allows the present system and methodology to move in and out of individual equity positions as well as the market as a whole in a nimble, quick manner. It also acts as a risk minimization technique such that the negative impact of any individual equity position is minimized in the overall portfolio. Therefore, in one embodiment, the present investment concepts limit a position in any individual investable entity to not be greater than 0.3% to 1% of the entire portfolio. While there may be exceptions to this limit, they will occur only when explicit situational opportunities are presented. For example, when sector analysis determines a particular sector has an expected higher than average sector return).

The aspect of moving in and out of individual stocks and/or the entire market rapidly by employing a large diversification, is enhanced by limiting the investments to investable entities having a market capitalization size where liquidity issues for buying and selling stock is not problematic (e.g., in one embodiment this is identified as being investable entities which are not less than approximately $1 billion dollars in market capitalization). This allows for the exit from an equity position or a portfolio of equity positions quicker than investment portfolios having large stakes in a smaller number of investable entities. Particularly, in portfolios having a large amount of stock a single investable entity could require days to completely exit the position, and such exit would tend to depress the exit price obtained. On the other hand portfolio created using the present concepts are constructed to be able to exit the entire position (total portfolio) within 1 to 2 hours or less of making an exit decision.

Returning to Standardized Financial Data module 42, it is noted that in the past if an attempt was made to hold a large number of different positions (i.e., 100-300) the result would be a haphazard accumulation, with at best only a superficial investigation as to the value of the investable entities. The ability to analyze and compare a large number of investable entities in the manner undertaken in the present application was not possible for number of reasons. Initially, the financial data was not presented to the public in a timely fashion such that analysis could be done in a timely manner on a large number of different investable entities. Second, even when the financial data was obtained the information provided was in a non-standardized format. For example, Company A might define depreciation using a number of different names and criteria, while Company B might have its own terminology and manner of identifying depreciation. Thus, both within a company and between different companies the concepts of depreciation (as well as other financial concepts) would be identified and reported in accordance with distinct nomenclatures and interpretations. This meant attempting to thoroughly analyze the financial information supplied by an investable entity and then further attempting to compare such analysis against other investable entities was not practical over a large number of investable entities (e.g., 600-800 or other number of the 6500 publically traded companies in the United States) in a timely manner. However, with the recently implemented EDGAR and XBRL based reporting, standardization of financial data has increased which permits for reliable analysis across a broad spectrum of investable entities, such as undertaken by Risk Adjusted Discount Cash Flow (DCF) module 44.

Risk Adjusted Discount Cash Flow (DCF) module 44 employs a modification of the industry accepted discounted cash flow (DCF) analysis which values an investable entity (e.g., company) based on current transparent operating performance. Generally, analysis of an investable entity under existing DCF focuses on operating performance by identifying cash flow and estimated growth potential. However as a modification to the existing DCF process, the risk adjusted DCF analysis of the present application emphasizes analysis of the volatility of the investable entity. Particularly the present system and methodology views an investable entity as not only having operating functions (i.e. manufacturing and selling products and/or services) which are used to generate the cash flow and growth estimates, but also as having a banking operation aspect (i.e. providing capital to suppliers, buying debt or issuing debt, determining a dividend rate, buying equity and issuing equity, acquiring assets such as other companies, and so on). So it is understood in the present system and methodology that even if under accepted DCF analysis the operational side of an investable entity is performing well, other aspects also have major impacts on the value of the investable entity. Therefore, in addition to taking into account operating performance of an investable entity, the risk adjusted DCF analysis of the present application further focuses on the banking operation volatility of the investable entity and business area or sector volatility. More specifically, the risk adjusted DFC analysis investigates the efficiency of the banking operations of the investable entity and reviews the investable entity in the context of the total competitive environment to understand the volatility of the sector, business area, etc., in which the investable entity is located. The present system and methodology considers that if an investable entity is well-run, then not only will the operating performance be positive, but the banking operations of the investable entity will also have low volatility. Therefore, whereas existing DCF analysis concepts focus substantially on cash flow and growth rate of an investable entity, the risk adjusted DCF takes a finer grained analysis.

Turning attention to Liquidity/Bankruptcy Analysis module 46, this module may (optionally) be applied once the Risk Adjusted DCF module 44 has identified a value for an investable entity. While in some embodiments, the value indicator may be sufficient to buy stock at the determined price, a further safeguard looks at how the debt of the valued investable entity is trading in the marketplace. Typically, investable entities are required to provide covenant reporting, which may not be readily available until the submission by an investable entity of their 10-Q. However, if an investable entity is in a financially tenuous position, this would be too late for a bank which may be looking to loan money to the investable entity. There are private debt markets, which determine the value of debt of an investable entity, and which may be monitored to determine the health of such debt. Liquidity/Bankruptcy Analysis module 46 uses the data from these sources to determine the liquidity and possible bankruptcy potential for the investable entity being analyzed. If the investable entity is found to be in an unacceptable risk, the equity of the investable entity is not purchased even though the risk adjusted DCE analysis determines it to be a buy situation. It is appreciated that in FIG. 2 the Liquidity/Bankruptcy Analysis module 46 receives data both from the risk adjusted DCF module 46 as well as data from the Standardized Financial Data module 42. It is to be understood that while Standardized Financial Data module 42 has been described as including standardized financial data (e.g., in an XBRL format), data not in such a format may also be located within the module, such as the data that could be used is used by the Liquidity/Bankruptcy Analysis module 46. Alternatively the data regarding debt could be supplied though another communication arrangement.

From the above it is seen that use of the Risk Adjusted DCF module 44 and optionally the Liquidity/Bankruptcy Analysis module 46, results in an output indicating a stock price at which shares of an analyzed investable entity should be purchased to consider the purchase an acceptable value. The use of electronically available standardized financial data reporting allows for this decision making process to be accomplished substantially instantaneously with the release of the standardized financial data. For example, in one embodiment, an investable entity will submit its required financial data reporting (e.g. performance data including 10K reports, etc.) with the Securities Exchange Commission (SEC) in a standardized reporting format (XRBL) which is received by their internal EDGAR system. The SEC will electronically provide such filing information to a commercial reporting organization (e.g. EDGAR Online) substantially instantaneously as it is available. It is then possible for an investment organization, such as one employing the system and methodology of the present application to perform a detailed, consistent analysis of the reporting companies substantially immediately, to determine a particular stock value for the particular investable entity. In other embodiments the standardized financial data is obtained at predetermined calendar dates as a database transferred to the investing organization, and maintained on the investing organizations own database. Still further it may be possible to obtain the data directly from the SEC.

Before the standardization of financial reporting (i.e., before XRBL and EDGAR), the process of obtaining the data (e.g. to 10K reports) from the SEC itself would take potentially days. Then even after obtaining the data the process to analyze a particular company would take additional hours. Still further, comparing the analysis between companies would take yet further time. All in all, to determine a particular buy position for one particular investment entity could take 20 hours or more. Then, if one is investigating large numbers of investable entities (e.g. 600 to 800 of the publicly traded companies in the United States—much less the entire range of the approximately 6500 public US companies) it would take over a year to analyze each individual company. Thus the ability to undertake consistent DCF type analysis on a broad scope (600-800 companies) would not be possible in a timeframe which would allow for selecting and maintaining between 100 to 300 positions. This is particularly true in an actively traded account, where further rules require re-analysis, exit and re-entry within set time periods, such as 15 months.

With continuing attention to FIG. 2, Market Cycle Analysis module 48 is used to determine whether the portfolio in its entirety should be maintained within a securities market or should the portfolio exit the market. To assist in this determination the concept of expectational math is referenced. In the idea of expectational math, if a portfolio intends to return 5% growth per year, it would be understood that the portfolio expects to return 1.25% growth per quarter. Therefore, under expectational math. If the portfolio is up 1.25% at the end of the first quarter (but this increase has not been realized by exiting the investable entities) expectational math states the portfolio is actually −1.25% from its 5% goal, as the first quarter passed and no profits being realized. If at the end of the first quarter, the 1.25% up side is realized then instead of a return of 98.75% (i.e., 100%−1.25%=98.75%), the portfolio has returned 101.25% (100%+1.25%=101.25%). Therefore the idea of looking at investments under the idea of expectational math serves to focus on the need to harvest returns on a frequent basis.

With continuing attention to the Market Cycle Analysis module 48, expectational math encourages the preservation of assets over unwarranted risk taking. In view of this and based on investigation and analysis of historical data, it has been determined that when there is downward movement in the overall US equity market (based on the Dow Jones Market average) of between −X % and −Y %, then the overall market decline will continue until the market is down −X %−N %, and this will happen about 100% of the time. Further, from that −X %−N % decline the market will go down to another −N % to −X %−2N %, about 50% of the time. It is also been determined through analysis that the market will require at least about six (6) months to return to even from the −X %−N % value. Therefore, the present methodology includes a rule that when the market reaches between −X % and −Y % position, all equity holding in the portfolio will be exited and the portfolio will move to a 100% non-equity position. The next rule is that reentry into the equity market will be delayed for at least between 3 and 6 months from the −X % to −Y % date. It is understood that the methodology of the present application in this regard relies on the concept of renting capital as opposed to purchasing capital in the sense that where mutual funds essentially purchase and hold, the present methodology believes that capital is being rented and when the rents (i.e., stock prices) are higher than reasonable the methodology will move the portfolio to another asset class. Where in at least one embodiment −X %, −Y % and −N % are based on trailing 20-year market cycles and desired risk absorption levels.

In the above described embodiment, market cycle analysis (i.e., determining whether the portfolio should be entirely removed from the market) is undertaken viewing the entire market in which the portfolio is located. However, in other embodiments, the market cycle analysis may be applied to an individual sector or some sub-set of sectors of the overall market (i.e. manufacturing, industrial, services, etc.). Then entry and/or exit from equity positions would be for only the equity positions within the individual sector or sub-set of sectors.

With attention to the Rule module 49 of FIG. 2, this module contains information related to equity positions held by the portfolio including the date the equity positions were entered. Module 49 includes a time driven trigger which requires an equity position to be exited T months from the date of purchase of the stock. A factor for instituting the T month exit rule includes the issue of capital gains taxes, which imposes an approximate 20% penalty on a sale of a stock which has not been held for more than a year. An additional factor in implementing the T month exit rule is the concept of slope management. More particularly, in investigating and analyzing historical data, it is seen that once a value stock position has been identified. The slope or increase of appreciation in the value of that stock price will be at a steeper slope during the first T months from the time it is identified when compared to hold periods extending past T months. For example, a slope in the first T months will be steeper (the return on the stock may be 6% in the first T months) but thereafter the slope will historically start to flatten out (stock may appreciate 2% in the next T months). Where T is a selectable number of months.

Holding onto a stock is therefore in competition with time and the identification of other identified investable entity values. In one manner this is understood to be a slope jumping concept where the identification of new values at that T month exit time would allow the resources (i.e. cash) to be or moved to an investable entity with a perceived greater slope in the next T month period. It is to be understood that a stock of an investable entity which is being exited due to the T month rule will be re-analyzed to determine whether the investable entity is still considered a value (e.g., the risk adjusted DCF analysis is applied). If under this new analysis it is determined to still be a value proposition, the position will be maintained for another T months.

The T month exit rule also acts as an automatic portfolio rebalancing operation. It is to also be considered that as the capital gains aspect is a governmental imposed cost it could in the future be increased or decreased. In this situation the T month rule might be altered to rely more or less heavily on slope management.

In one embodiment employing the concepts of the present application approximately 70% of the stock buys may be made within a 1 to 2 week time frame from the disclosure of the standardized financial data.

Further in an embodiment where 600 to 800 public companies are being analyzed, there will be approximately 150 to 200 in a bottom range. By analysis, it is been estimated that approximately 50% of those 150 to 200 become come value buys during the remainder of the calendar year. In other words, another percent of the analyzed companies will present themselves as values based on the initial valuation. In other words it may be determined that an investable entity buy stock price would be a value at $15 a share. But at the time of the analysis the stock may be trading at $20 per share. Throughout the year the stock will fluctuate and at some point may present itself as a $15 share price. Then, at this point, it becomes a potential buy.

Another buying opportunity occurs where 20% of the original 70% of potential positions become stronger buys due to a “V” spike in the stock. Where a “V” spike represent a further price decline (e.g. 20%) which is not due to any issues which would lower the RA-DCF analyzed price. Therefore, the present system and methodology finds stock values which are at the values (i.e. 20% below estimated value) and also deep value stocks (stocks that have traded yet a further 20% down).

Turning now to FIG. 3, depicted is a block diagram of a multicap value investment methodology 50 according to the present concepts. Those skilled in the art will appreciate that the methodology 50 is merely illustrative of a particular process flow and that variations thereof are contemplated. In that regard, the actions disclosed were described and illustrated in a sequential fashion for ease of discussion. However, parallel processing of the steps is contemplated as well as a different ordering of the process steps.

Also, it is understood that attempting to implement methodology 50 by hand, i.e., without the use of a processing system such as system 10 described in FIG. 1, would not allow the generation of data in a usable timeframe. In other words, if one were to attempt to process the data process by methodology 50 without the use of the described processing systems, by the time any results were obtained, the time when such results would have been useful would have passed.

Methodology 50 includes determining 52 whether an inhibition period is set. An inhibition period being understood as the time period in which investing in the market is prohibited. In other words, the investment portfolio is completely out of the equity market. As discussed hereafter, the inhibition period is set in response to a market cycle downturn. When it is determined that an inhibition period exists, the determination 52 is repeated until the inhibition period has passed. In some embodiments, a delay is interposed. When it is determined that an inhibition period does not exist, market cycle analysis is undertaken to determine if the current market cycle is in a downturn 54.

A market cycle downturn is a period of negative growth in the market and it is suitably detected through the use of a classifier. However, other approaches to detecting a market cycle downturn are amenable. The classifier takes as input features of the current market cycle and classifies the current market cycle as in a downturn or an upturn based on the features.

Features are variables defining the state of the market which discriminate between a market cycle downturn and a market cycle upturn. For example, a feature may be the average rate of decrease or increase of a metric of performance for the market over a predetermined period of time. Such a metric includes, for example, a standard market index or custom market index calculated from data in the database 12. Features of the current market cycle are extracted from the data in the database 12, and can be directly extracted from the data or indirectly extracted therefrom through calculation.

The classifier takes the extracted features and determines whether the market cycle is in a downturn or an upturn. The classifier can use, for example, thresholds, learning classifiers, such as a Naive Bayes classifier, and the like. For example, where the market value drops below a certain value (e.g., a percentage of current value, a fixed value, a percentage of 52 week high, etc.), the market is deemed to be in a market cycle downturn.

Where a learning classifier is employed, the classifier can be trained on previous market cycles. In such embodiments, a set of features is extracted from data for each of the previous market cycles. Each feature set is then classified as either indicative of a market cycle downturn or a market cycle upturn. Typically, this classification is performed by an operator of the analysis system 14. The classified feature sets are then employed to train the classifier.

When it is determined that the current market cycle is in a downturn, an inhibition period is set 56, thereby prohibiting investing in the market until the inhibition period elapses. The operator of the analysis system 14 through experience typically determines the length of the inhibition period, which in one embodiment is a 6-month time period. On the other hand, if it is determined the market cycle is not in a downturn, the process moves to step 60, where RA-DCF values are calculated for the investable entities over a predetermined period of time, typically 20 years. Suitably, the RA-DCF values are determined using the data in the database 12, including the performance data for the investable entities.

A RA-DCF for an investable entity is determined by valuing the sum of risk adjusted core cash flow and share repurchase carry over a predetermined period of time. Put another way, all future cash flows, both incoming and outgoing, for an investible entity over a predetermined period of time are estimated and discounted to their present values. The present values are summed and the summation is discounted according to risk associated with the investable entity. The discount is proportional to the amount of the risk.

The risk of an investable entity is typically determined from the volatility of the investible entity relative to the market. In some embodiments, the beta of the investable entity is employed. Beta is the measure of an investable entities risk in relation to the market. For example, a beta of 0.7 means the fund's total return is likely to move up or down 70% of the market change, and a beta of 0.3 means total return is likely to move up or down 30% of the market change. While risk is typically determined from the volatility of the investable entity relative to the market, other approaches to determining the risk of an investible entity are equally amenable.

In some embodiments, RA-DCF values are only calculated for investable entities with a market capitalization exceeding a predetermined amount, such as $1 billion. Further, in some embodiments, RA-DCF values are only calculated for investable entities with certain sectors of the market. For example, investable entities in the sectors of basic materials, capital goods, consumer non-cyclical, consumer cyclical, services, energy, health, technology, transportation and conglomerates are considered, whereas investable entities in the sectors of financial and utilities are not considered.

A rebalance determination 62 is next made as to whether to rebalance the investment portfolio. Rebalancing is appropriate when one or more trigger events and/or conditions have occurred. One trigger is the passing of timeouts for one or more investable entities invested in with the investment portfolio. As discussed hereafter, when an investable entity is invested in (i.e., equity securities are purchased), a timeout period is set for a predetermined period of time. Another trigger is the number of investable entities invested in being less than the target diversification amount, such as 200. The target diversification amount is a target for the number of investable invested to be invested in. Other triggers are also contemplated.

When it is determined that it is not time to rebalance the investment portfolio, the process 50 returns to step 54 to determine whether there is a market cycle downturn. Otherwise, when it is determined that it is time to rebalance the investment portfolio, up to a predetermined number investable entities having a determined best value (i.e., they have a deep value) are selected 64. The selected investable entities are those with corresponding current stock market values less than a stock value determined by RA-DCF calculations. Typically, when an investable entity is out of favor, the stock market will discount the investable entity below the RA-DCF value. The best potential investable entities are those with the largest difference between corresponding current market values and corresponding RA-DCF values.

In some embodiments, the potential investable entities worth investing in must further pass a liquidity-bankruptcy test. The liquidity-bankruptcy test determines whether the value of debt securities of an investable entity is falling, on average, over a predetermined period of time. If so, the investable entity fails the test; otherwise, the investable entity passes the test. Further, in some embodiments, the investable entities are selected to maintain a certain ratio of sectors. For example, the investable entities are selected so 40% of the investable entities selected are part of the health care sector and 60% are from the technology sector.

The predetermined number of investable entities that are selected varies depending upon the trigger. When the trigger is the passing of timeouts for one or more investable entities invested in, the predetermined number is the number of investable entities with timeouts that passed. When the trigger is the number of investable entities invested being less than the target diversification amount, the predetermined number is the difference between the target diversification amount and the number of currently invested investable entities. For other triggers, the predetermined number will be dependent on these trigger. In some instances, the predetermined number will exceed the number of investable entities worth investing in.

To illustrate the selection 64, a predetermined number of the best investable entities can be selected by first selecting the investable entities with current market values less than the RA-DCF values. These investable entities are then ranked according to difference between RA-DCF value and current market value. Starting with the investable entity with the largest difference, if the liquidity-bankruptcy test is passed, the investable entity is selected as one of the predetermined number of the best investable entities. The liquidity-bankruptcy test is then repeated on the investable entity with the next largest difference, which is selected if it passes the test. This process repeats until a predetermined number of the best investable entities are selected or all the investable entities worth considering are considered.

After selecting 64 the best investable entities, timeouts are set 66 for the selected investable entities. The timeout is typically between 1 year and 2 years, but preferable 15 months. The timeout recognizes that after a certain amount of time passes, the rate of growth for an investable entity typically slows or drops. Hence, the optimal value can be determined by running simulations to determine at what point the rate of growth typically decreases for investable entities. In addition to advantageously improving time value accretion, the timeout advantageously provides unemotional harvest, forced reallocation, and risk management (against market cycles).

In addition to setting timeouts, the investment portfolio is rebalanced 68 by entering the market and purchasing shares of the selected investable entities. The methodology 50 restarts by, for example, again determining 52 whether there is an inhibition period. Rebalancing includes one or more of changing the ratio of cash and/or investable entities comprising the investment portfolio. As with the selection 64, the rebalancing 68 depends upon the cause of the rebalancing. In other words, the rebalancing depends upon whether it was caused by a market cycle downturn, timeouts, the portfolio having fewer investments than the target diversification amount, and so on.

When the reason for the rebalancing is a market cycle downturn, all equity securities of the investment portfolio are sold thereby moving the investment portfolio to non-equity investments. In other words, the investment portfolio is removed from the market. Leaving the market upon detecting a predetermined amount of market cycle downturn serves as a risk management action. There is enough view and volatility risk in moving to a non-equity position without accentuating the risk by pursuing the short term directional change with shorting and leverage of the equities.

When the reason for the rebalancing is the passing of timeouts for one or more investable entities held in the investment account, the timed out investable entities are replaced by the selected entities. In some instances, there may be overlap between the selected identifiable entities and the timed out investable entities. In other words, an investable entity within the portfolio may have reached its “timed-out” period. However, when the RA-DCF calculations are performed, this investable entity is identified as still being a best value. In this situation that investable entity will be maintained in the portfolio. Therefore, the replacement operation includes selling the timed out investable entities not part of the selected investable entities and buying the selected investable entities not part of the timed out investable entities.

When the reason for rebalancing is that the number of investable entities held in the investment portfolio is less than the target diversification amount, the selected investable entities are purchased. As noted above, the target diversification amount is the target number of investable entities invested in. Suitably, the target diversification amount is large to allow for diversification and risk management.

The buying of equity securities is suitably performed with cash in the investment account. However, in some embodiments, a portion of the buying can be performed with borrowed money. For example, equity securities can be purchased with a predetermined amount of borrowed money, which can be repaid upon selling the equity securities. It is also contemplated, that conditions can be employed to determine when to purchase equity securities with borrowed money and/or how much borrowed money to employ. The conditions can be based on, for example, market features, such as the features employed for classifying a market cycle as being in a downturn or an upturn.

Each investable entity being invested is typically allocated an equal amount of the available money for buying equity securities, including cash and/or borrowed money. For example, each investable entity being invested in can be allocated an amount equal to the available money divided by the difference between the target diversification amount and the number of investable entities invested in. In other embodiments, each investable entity being invested in can be allocated an amount weighted based on its difference between the DCF value and the current market value. Other schemes for allocating available money to the purchase of equity securities in the investable entities are equally amenable.

As noted above, actually carrying out the rebalancing 68 to change the composition of the investment portfolio can require action of an operator of the analysis system 14 or be automatic without action of the operator. As to the former, the determined composition of the investment portfolio is output to the user output device 18, such as a display. It then falls to the operator to rebalance the investment portfolio according to the determined composition. As to the latter, the determined composition is sent to the investment portfolio system 20.

The methodology 50 was back tested over the past 12 years for investable entities exceeding market capitalizations of $1 billion. The methodology 50 achieved average annual returns of 19.5% with a standard deviation of less than 25%. Hence, it greatly outperformed all large cap and multicap value funds tracked by the Morningstar and Lipper mutual fund ratings systems. Seven and one/half out of ten trades were positive across 4464 trades over the most difficult decade in 80 years. Further, it achieved this at volatility equal to or lower than the best active funds. FIG. 4 illustrates the annual return for the methodology 50 compared to the S&P 500.

Those skilled in the art will appreciate that the methodology 50 was merely illustrative and that variations thereof are contemplated. In that regard, the actions disclosed were described and illustrated in a sequential fashion for ease of discussion. However, parallel processing of the steps is contemplated. For example, the calculation 60 of the RA-DCF values can be performed independent and/or in parallel with the other actions in response to periodic timer events, the availability of new data, and so on. As another example, multiple triggers can be processed in parallel.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), and the like; a user output device includes a display, such as a plasma display, liquid crystal display, cathode ray tube display, and so on, printer, and so on; and a user input device includes one or more of a mouse, a keyboard, a touch screen display, one or more buttons, one or more switches, one or more toggles, and the like.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A system for managing an investment portfolio, said system comprising:
at least one processor programmed to:
receive performance data for a plurality of investable entities forming a market;
calculate risk adjusted discount cash flow (RA-DCF) values for the investable entities using the received performance data; and,
in response to at least one trigger:
select a predetermined number of the investable entities with RA-DCF values less than corresponding current market values; and,
rebalance the investment portfolio to include the selected investable entities.

2. The system according to claim 1, further including:
a database including the performance data for the investable entities.

3. The system according to claim 1, wherein the performance data for the investable entities includes 10-K statements.

4. The system according to claim 1, wherein the processor is further programmed to:
determine whether a market is in a cycle downturn; and,
in response to determining the market is in cycle downturn, move the investment portfolio out of the market.

5. The system according to claim 4, wherein the processor is further programmed to:
in response to determining the market is in a cycle downturn, set an inhibition period on investing in the market.

6. The system according to claim 1, wherein the processor is further programmed to:
in response to investing in an investable entity, setting a timeout for the investable entity.

7. The system according to claim 6, wherein the trigger includes the timeout for an investable entity passing.

8. The system according to claim 6, wherein the timeout is between 1 and 2 years.

9. The system according to claim 1, wherein the trigger includes the number of investable entities invested in being less than a target diversification amount.

10. The system according to claim 1, wherein the RA-DCF values are risk adjusted DCF values proportionality discounted according to corresponding risks.

11. The system according to claim 10, wherein the corresponding risks are determined from volatility of corresponding investable entities relative to the market.

12. The system according claim 1, wherein the selected investable entities pass a liquidity-bankruptcy test, wherein the liquidity-bankruptcy test determines whether value of debt securities of an investable entity are falling on average over a predetermined period of time.

13. The system according to claim 1, further including:
a user output device, wherein the rebalancing includes outputting the selected investable entities with the user output device.

14. A method for managing an investment portfolio, said method comprising:
receiving performance data for a plurality of investable entities forming a market;
calculating by at least one processor risk adjusted discount cash flow (RA-DCF) values for the investable entities using the received performance data; and,
in response to at least one trigger:
selecting by the processor a predetermined number of the investable entities with RA-DCF values less than corresponding current market values; and,
rebalancing the investment portfolio to include the selected investable entities.

15. The method according to claim 14, further including:
determining whether a market is in a cycle downturn; and,
in response to determining the market is in cycle downturn, moving the investment portfolio out of the market.

16. The method according to claim 15, further including:
in response to determining the market is in a cycle downturn, setting an inhibition period on investing in the market.

17. The method according to claim 14, wherein the performance data for the investable entities includes 10-K statements.

18. The method according to claim 14, further including:
in response to investing in an investable entity, setting a timeout for the investable entity.

19. The method according to claim 18, wherein the trigger includes the timeout for an investable entity passing.

20. The method according claim 14, wherein the selected investable entities pass a liquidity-bankruptcy test, the liquidity-bankruptcy test determining whether value of debt securities of an investable entity are falling on average over a predetermined period of time.

21. A computer program product, comprising a computer usable medium having a computer readable program code embodied therein, said computer readable program code adapted to be executed to implement a method for managing an investment portfolio, said method comprising:
receiving performance data for a plurality of investable entities forming a market;
calculating by at least one processor risk adjusted discount cash flow (RA-DCF) values for the investable entities using the received performance data; and,
in response to at least one trigger:
selecting by the processor a predetermined number of the investable entities with RA-DCF values less than corresponding current market values; and,
rebalancing the investment portfolio to include the selected investable entities.
